(19) United States
(12) Patent Application Publication
(10) Pub. No.: US 2025/0179900 A1
(43) Pub. Date: Jun. 5, 2025

(54) CRUDE OIL RECOVERY METHOD

(71) Applicant: Japan Petroleum Exploration Co., Ltd., Chiyoda-ku, Tokyo (JP)

(72) Inventors: Ayae ITO, Tokyo (JP); Daisuke ITO, Chiba-shi (JP); Yutaro KAITO, Chiba-shi (JP)

(73) Assignee: Japan Petroleum Exploration Co., Ltd., Chiyoda-ku, Tokyo (JP)

(21) Appl. No.: 18/033,986

(22) PCT Filed: Dec. 22, 2021
(86) PCT No.: PCT/JP2021/047607

§ 371 Date: Jan. 27, 2025

(51) Int. Cl. E21B 43/16; C09K 8/594

(52) U.S. Cl. CPC E21B 43/16; C09K 8/594; C09K 2208/10

(57) ABSTRACT

This method for recovering crude oil has a reservoir modification fluid injection step of pressing and injecting, through an injection well into a crude oil-containing reservoir between the injection well and a production well, a reservoir modification fluid that reforms the wettability of the reservoir, a primary crude oil recovery step of pressing and injecting an overflush fluid through the injection well into the reservoir, thereby moving the crude oil contained in the reservoir from a side of the injection well toward a side of the production well, and enabling recovery of the crude oil from the reservoir via the production well, and a secondary crude oil recovery step of pressing and injecting a foam-stabilizing fluid and a foam-forming fluid through the injection well into the reservoir, thereby moving the crude oil contained in the reservoir from the side of the injection well toward the side of the production well, and enabling recovery of the crude oil from the reservoir via the production well.

### TECHNICAL FIELD

The present invention relates to a crude oil recovery method that enables crude oil to be recovered effectively.

### BACKGROUND ART

In oil fields that produce petroleum and gas fields that produce natural gas and the like, improving the productivity of the crude oil and gas is very desirable.

Accordingly, Patent Document 1 focuses on an issue that arises in strata near wellbores, where a condensate that exists in a gaseous state prior to the commencement of production, condenses due to the pressure reduction that accompanies production, and accumulates as condensate banking, thereby restricting the channels through which gas can flow, and dramatically lowering the productivity. Patent Document 1 proposes a method for improving gas productivity by using a fluid containing metal oxide nanoparticles to remove condensate banking.

The production of crude oil is generally classified into three phases known as the primary recovery, secondary recovery and tertiary recovery phases. In primary recovery, crude oil extraction is conducted by a natural flow method or the like that utilizes the natural energy within the reservoir, whereas in secondary recovery, a method in which water or gas is pressed and injected into the oil reservoir, or a method in which the crude oil is extracted using a pump or the like installed inside the bore is generally employed. However, even following primary recovery and secondary recovery, 60 to 70% of the crude oil still remains within the reservoir, and it is expected that further improvements in productivity will be achieved through tertiary recovery employing enhanced oil recovery (EOR) methods.

The EOR methods includes methods such as thermal injection methods, gas injection methods, chemical injection methods, and microbial injection methods.

In chemical injection methods, improvements in the crude oil productivity are achieved by pressing and injecting a chemical reagent into the oil reservoir.

Specifically, Patent Document 4 proposes a method for recovering crude oil by pressing and injecting a micelle solution containing a carbohydrate, salt water and a surfactant into the oil reservoir. Patent Document 6 proposes a method for recovering crude oil by adding an aqueous silica sol, an anionic surfactant and a nonionic surfactant to a treatment fluid, and then pressing and injecting the treatment fluid into the oil reservoir. Patent Document 7 proposes a method for recovering petroleum from a production well by preparing a silicon sol containing an acid solvent and a silicon-containing solute having acid solubility, obtained by mixing a silicon-containing substance and an alkaline substance and then conducting a heat treatment, pressing and injecting the silicon sol from an injection well into the oil reservoir, and then gelling the silicon sol. However, with these chemical injection methods, achieving adequate recovery of the crude oil has proven difficult.

On the other hand, in gas injection methods, a gas is pressed and injected into the oil reservoir of the oil field or gas field, thereby substituting the oil phase with a gas phase while maintaining the pressure inside the oil reservoir, enabling an improvement in the recovery rate from the oil field.

However, in gas injection methods, a problem arises in that the viscosity of the gas phase is low compared with the viscosity of the fluid within the strata containing the oil reservoir, and therefore the gas phase is readily discharged from the production well in the early stages, making it difficult to substitute the oil phase with the gas phase.

Accordingly, foam EOR methods are being investigated in which a process fluid containing a surfactant or the like is pressed and injected into the oil reservoir, either prior to the pressing and injecting of gas into the oil reservoir or when the gas is pressed and injected into the oil reservoir.

Patent Document 5 proposes a method for recovering crude oil by creating a foam from a gas and an aqueous solution containing a water-soluble surfactant, pressing and injecting this foam into the oil reservoir of an oil field, and using the gas to enhance the extraction efficiency. However, maintaining the foam inside the high temperature and high pressure environment of the oil reservoir is not easy, and Patent Document 3 investigates a method in which, in order to enhance the stability of the foam relative to high temperature, high pressure and salt water, a dispersoid of nanoparticles and a dispersion medium composed of an aqueous solvent with a pH of at least 1.0 but not more than 6.0 are added to the aqueous sol containing CO₂, water and oil that is used during foam formation.

Further, if a foam containing a surfactant remains in the oil reservoir for a long period, there is a possibility that the foam may have an impact on the environment, and therefore Patent Document 2 investigates a foam EOR method in which surface-modified nanoparticles are added to a process liquid containing a fluorinated surfactant, with the object of achieving defoaming of the foam.

### PRIOR ART LITERATURE

### Patent Documents

Patent Document 1: Japanese Translation of PCT International Application, Publication No. 2020-514494
Patent Document 2: Japanese Translation of PCT International Application, Publication No. 2005-526887
Patent Document 3: International Patent Publication No. WO 2021/107048 pamphlet
Patent Document 4: Japanese Unexamined Patent Application, First Publication No. Sho 59-44489
Patent Document 5: U.S. Pat. No. 2,866,507
Patent Document 6: Japanese Unexamined Patent Application, First Publication No. 2021-6595
Patent Document 7: International Patent Publication No. WO 2009/150698 pamphlet

### SUMMARY OF INVENTION

### Problems to be Solved by the Invention

However, the surfaces of the rock inside the oil reservoir following secondary recovery are often entirely or partially wet with oil. The foam EOR requires the formation of a thin membrane of water connecting between rock surfaces, and therefore a problem arises in that if the surfaces of the rock are wet with oil, then formation of this thin membrane of water connecting between the rock surfaces becomes difficult. Further, another problem is that in those cases where large amounts of crude oil exist within the rock pores, this crude oil acts as a defoaming agent, accelerating the breakdown of the thin membrane.

The present invention has been developed in light of the above circumstances, and has an object of providing a method for recovering crude oil that enables effective recovery of the crude oil even in the case of oil reservoirs in which the surfaces of the rock are wet with oil.

### Means for Solving the Problems

The present invention incorporates any of the following aspects.
[1] A method for recovering crude oil, the method including:
   a reservoir modification fluid injection step of pressing and injecting, through an injection well into a crude oil-containing reservoir between the injection well and a production well, a reservoir modification fluid that reforms the wettability of the reservoir,
   a primary crude oil recovery step of pressing and injecting an overflush fluid through the injection well into the reservoir, thereby moving the crude oil contained in the reservoir from a side of the injection well toward a side of the production well, and enabling recovery of the crude oil from the reservoir via the production well, and
   a secondary crude oil recovery step of pressing and injecting a foam-stabilizing fluid and a foam-forming fluid through the injection well into the reservoir, thereby moving the crude oil contained in the reservoir from the side of the injection well toward the side of the production well, and enabling recovery of the crude oil from the reservoir via the production well.
[2] The method for recovering crude oil according to [1], wherein the secondary crude oil recovery step is started during execution of the primary crude oil recovery step.
[3] The method for recovering crude oil according to [1], wherein the secondary crude oil recovery step is started following execution of the primary crude oil recovery step.
[4] The method for recovering crude oil according to any one of [1] to [3], wherein the reservoir modification fluid is at least one type of fluid selected from a group consisting of first nanoparticle-containing fluids, water vapor, surfactant-containing fluids, polymer compound-containing fluids, and low-salinity water.
[5] The method for recovering crude oil according to [4], wherein the first nanoparticle-containing fluid contains nanoparticles and a dispersion medium, and the nanoparticles have hydrophilicity.
[6] The method for recovering crude oil according to [5], wherein the nanoparticles are formed from one component, or two or more components, selected from a group consisting of silicon, aluminum, titanium, iron, zinc, copper, nickel, zirconium, tin and magnesium.
[7] The method for recovering crude oil according to [5] or [6], wherein the maximum particle size of the nanoparticles is at least 1 nm but not more than 100 nm.
[8] The method for recovering crude oil according to any one of [5] to [7], wherein the dispersion medium contains at least one fluid selected from a group consisting of water, natural gas, carbon dioxide, air, nitrogen, methane and hydrogen.
[9] The method for recovering crude oil according to [4], wherein the surfactant contained in the surfactant-containing fluid is one or more surfactants selected from a group consisting of cationic surfactants, anionic surfactants, amphoteric surfactants and nonionic surfactants.
[10] The method for recovering crude oil according to any one of [1] to [9], wherein the overflush fluid contains at least one fluid selected from a group consisting of water, natural gas, carbon dioxide, air, nitrogen, methane and hydrogen.
[11] The method for recovering crude oil according to any one of [1] to [10], wherein the foam-stabilizing fluid is at least one fluid selected from a group consisting of surfactant-containing fluids and second nanoparticles-containing fluids.
[12] The method for recovering crude oil according to any one of [1] to [11], wherein the foam-forming fluid is at least one fluid selected from a group consisting of natural gas, carbon dioxide, air, nitrogen, methane and hydrogen.

### Effects of the Invention

The present invention is able to provide a method for recovering crude oil that enables effective recovery of the crude oil even in the case of oil reservoirs in which the surfaces of the rock are wet with oil.

### BRIEF DESCRIPTION OF THE DRAWINGS

FIG. 1 is a cross-sectional schematic view illustrating one example of the method for recovering crude oil according to the present invention.

FIG. 2 is a cross-sectional schematic view illustrating an enlargement of the rock of the oil reservoir in the method for recovering crude oil according to the present invention.

FIG. 3 is a cross-sectional schematic view illustrating an enlargement of the rock of the oil reservoir in a conventional method for recovering crude oil.

### EMBODIMENTS FOR CARRYING OUT THE INVENTION

Examples of embodiments of the present invention are described below in further detail, but the present invention should not be interpreted as being limited by these embodiment.

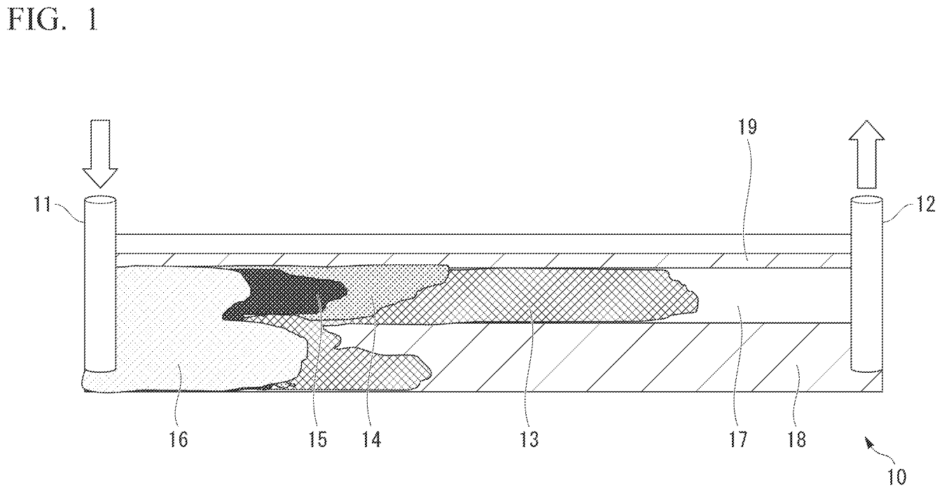

FIG. 1 shows a cross-sectional schematic view illustrating one example of the method for recovering crude oil according to this embodiment.

The method for recovering crude oil of this embodiment has a reservoir modification fluid injection step of pressing and injecting, through an injection well 11 into the reservoir of a crude oil-containing oil field 10 located between the injection well 11 and a production well 12, a reservoir modification fluid 13 that reforms the wettability of the reservoir, a primary crude oil recovery step of pressing and injecting an overflush fluid 14 through the injection well 11 into the reservoir, thereby moving the crude oil contained in the reservoir from the side of the injection well 11 toward the side of the production well 12, and enabling recovery of the crude oil from the reservoir via the production well 12, and a secondary crude oil recovery step of pressing and injecting a foam-stabilizing fluid 15 and a foam-forming fluid 16 through the injection well 11 into the reservoir, thereby moving the crude oil contained in the reservoir from the side of the injection well 11 toward the side of the production well 12, and enabling recovery of the crude oil from the reservoir via the production well 12.

In this embodiment, the crude oil includes crude oil that is recovered from the liquid-state fluid in the reservoir, and condensate that is recovered from the gas-state fluid in the reservoir.

### <Oil Field>

FIG. 1 illustrates an oil field 10 in which the injection well 11 and the production well 12 are provided in a reservoir having high-permeability oil reservoirs 17 located beneath a sealing layer 19, and low-permeability oil reservoirs 18 that has low permeability compared with the high-permeability oil reservoirs 17, but the crude oil recovery method of the present invention is not limited to this particular application.

### <Reservoir Modification Fluid>

The reservoir modification fluid 13 in this embodiment is a fluid that reforms the surfaces of the rock of the reservoir (oil reservoir) of the oil field 10 from an oil-wetting to a water-wetting.

This reformation from an oil-wetting to a water-wetting means the surfaces of the rock in the oil reservoirs change from a relatively oil-wetting to a relatively water-wetting.

The reservoir modification fluid 13 is at least one type of fluid selected from the group consisting of first nanoparticle-containing fluids, water vapor, surfactant-containing fluids, polymer compound-containing fluids, and low-salinity water.

The first nanoparticle-containing fluid contains nanoparticles and a dispersion medium, and the nanoparticles preferably have hydrophilicity.

Nanoparticles formed from one component, or two or more components, selected from the group consisting of silicon, aluminum, titanium, iron, zinc, copper, nickel, zirconium, tin and magnesium can be used as the nanoparticles having hydrophilicity. Nanoparticles formed from two or more of the above components may be composed of a composite formed from two or more components, and examples include composites of silicon and iron, and composites of silicon and titanium.

Silicon and aluminum and the like are preferred, as they contain the same silicon and aluminum that represents a major component of the rock such as sandstone and mudstone that forms the oil reservoirs, and therefore adsorb readily to the rock within the oil reservoirs, and can readily alter the surfaces of the rock from an oil-wetting to a water-wetting.

Further, due to the effects of structural disjoining pressure, the nanoparticles also have the effect of stripping away crude oil that exists on the surfaces of the rock, meaning the surfaces can be efficiently changed from an oil-wetting to a water-wetting.

The maximum particle size of the nanoparticles is preferably at least 1 nm but not more than 100 nm. Provided the maximum particle size of the nanoparticles falls within this range, the nanoparticles can also adsorb inside the rock pores, enabling the reformation from an oil-wetting to a water-wetting.

In particular, if the maximum particle size of the nanoparticles is 40 nm or less, then the first nanoparticles-containing fluid can be pressed injected into not only the high-permeability oil reservoirs 17, but also into the low-permeability oil reservoirs 18, which is particularly desirable.

The dispersion medium of the first nanoparticle-containing fluid is preferably at least one fluid selected from the group consisting of water, natural gas, carbon dioxide, air, nitrogen, methane and hydrogen.

The water may be any water that can be prepared easily on site, and salt water or the like may also be used.

Further, carbon dioxide includes not only gaseous or liquid carbon dioxide, but also supercritical carbon dioxide.

In the first nanoparticle-containing fluid, the nanoparticles content is preferably at least 0.05 wt % but not more than 5.0 wt %, and is more preferably at least 0.05 wt % but not more than 0.5 wt %.

Provided the blend ratio between the nanoparticles and the dispersion medium in the first nanoparticle-containing fluid satisfies the above range, the rock of the oil reservoir can be reformed efficiently from an oil-wetting to a water-state state while moving the first nanoparticle-containing fluid from the side of the injection well 11 toward the side of the production well 12.

Water vapor is a fluid that reaches a temperature above boiling point under the pressure of the reservoir, and exists in the form of steam.

It is thought that when water vapor is supplied through the injection well 11 to the oil reservoir, the steam causes desorption of at least a portion of the polar components in the crude oil adsorbed to the surfaces of the rock inside the oil reservoir, thus enabling the surfaces of the rock to be altered from an oil-wetting to a water-wetting.

Fluids containing a surfactant and a solvent can be used as the surfactant-containing fluid. It is thought that when the surfactant-containing fluid is supplied through the injection well 11 to the oil reservoir, the surfactant causes desorption of at least a portion of the polar components in the crude oil adsorbed to the surfaces of the rock inside the oil reservoir, thus enabling the surfaces of the rock to be altered from an oil-wetting to a water-wetting.

The surfactant may be any surfactant that is capable of lowering the surface tension of the crude oil covering the surfaces of the rock inside the oil reservoir, thus enabling the rock surfaces to be altered from an oil-wetting to a water-wetting, and one or more surfactants selected from the group consisting of cationic surfactants, anionic surfactants, amphoteric surfactants and nonionic surfactants may be used.

Water or CO₂ or the like can be used as the solvent.

Fluids containing a polymer compound and a solvent can be used as the polymer compound-containing fluid. The polymer compound may be any polymer for which at least a portion of the injected polymer compound adsorbs to the surfaces of the rock or is trapped inside fine pores in the rock, thus enabling the surfaces of the rock to be altered from an oil-wetting to a water-wetting.

Specifically, polymer compound-containing fluids containing a solvent such as water and one or more polymer electrolytes selected from the group consisting of polycations, polyanions and polysalts may be used. More specific examples include polymer compound-containing fluids obtained by adding a polymer compound such as a polysaccharide and/or a polyacrylamide or the like to a solvent such as water.

Low-salinity water refers to water having a lower salinity than the salinity concentration of groundwater that exists naturally inside the oil field. When a low-salinity water is supplied through the injection well 11 to the oil reservoir, an exchange occurs between the divalent cations at the surfaces of the rock inside the oil reservoir and the monovalent cations of the low-salinity water, suppressing interactions between the hydrophilic polar components adsorbed to the surfaces of the rock and the rock itself. It is thought that as a result of this type of action of the low-salinity water, at least a portion of the hydrophilic polar components adsorbed to the surfaces of the rock undergo desorption, enabling the surfaces of the rock to be altered from an oil-wetting to a water-wetting.

When the aforementioned water vapor, surfactant-containing fluid, polymer compound-containing fluid, or low-salinity water is used as the reservoir modification fluid 13, the rock of the oil reservoir can be reformed efficiently from an oil-wetting to a water-wetting.

### <Overflush Fluid>

The overflush fluid 14 may be any fluid that is capable of moving the crude oil that has been released from the surfaces of the rock in the reservoir modification fluid injection step from the side of the injection well 11 toward the side of the production well 12, and preferably contains at least one fluid selected from the group consisting of water, natural gas, carbon dioxide, air, nitrogen, methane and hydrogen.

The carbon dioxide includes not only gaseous or liquid carbon dioxide, but also supercritical carbon dioxide.

The water may be any water that can be prepared easily on site, and salt water is particularly preferred.

In the oil field 10, depending on the composition of the rock that constitutes the oil reservoir, the injection of fresh water can sometimes cause swelling of the reservoir, thereby blocking the flow channel. In these types of oil reservoirs, it is preferable that the composition of the rock is taken into consideration, and salt water is used for the injection.

### <Foam-Stabilizing Fluid>

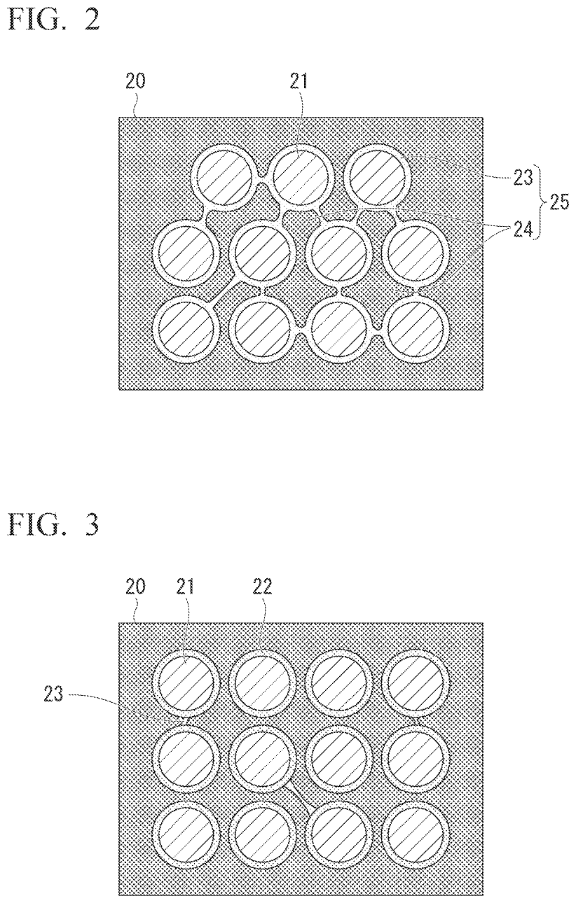

The foam-stabilizing fluid 15 may be any fluid which, as illustrated in FIG. 2, stabilizes a foam 25 formed between the surfaces of the rock 21 inside the oil reservoir 20, thereby improving the recovery of crude oil, and the use of at least one fluid selected from the group consisting of surfactant-containing fluids and second nanoparticle-containing fluids is preferred.

Here, the foam 25 is formed from gas bubbles (a gas phase) 24 derived from the foam-forming fluid 16, and a thin membrane 23 of water that surrounds the gas bubbles 24.

Fluids containing a surfactant and a solvent can be used as the surfactant-containing fluid. In this embodiment, the reservoir modification fluid injection step changes the characteristics of the surfaces of the rock of the oil reservoir from a relatively oil-wetting to a relatively water-wetting. Accordingly, a surfactant having powerful foaming characteristics need not be used, and a surfactant such as a typical anionic surfactant or amphoteric surfactant may be used. Water or CO₂ or the like can be used as the solvent.

It is preferable that the second nanoparticle-containing fluid contains nanoparticles and a dispersion medium, wherein the nanoparticles have a foam-stabilizing action.

The maximum particle size of the nanoparticles is preferably at least 1 nm but not more than 200 nm, and is more preferably less than 30 nm. Further, amphiphilic nanoparticles or the like that have undergone a surface treatment may also be used as the nanoparticles. Water or CO₂ or the like can be used as the dispersion medium.

In the second nanoparticle-containing fluid, the nanoparticles content is preferably at least 0.05 wt % but not more than 5.0 wt %, and is more preferably at least 0.1 wt % but not more than 0.5 wt %.

### <Foam-Forming Fluid>

The foam-forming fluid 16 may be any fluid that can be used in combination with the foam-stabilizing fluid 15 to form the foam 25, and at least one fluid selected from the group consisting of natural gas, carbon dioxide, air, nitrogen, methane and hydrogen is preferred. The carbon dioxide includes not only gaseous or liquid carbon dioxide, but also supercritical carbon dioxide.

The crude oil recovery method of the present invention is described below in further detail using a series of examples of specific embodiments.

### Embodiment 1

### <Reservoir Modification Fluid Injection Step>

In the reservoir modification fluid injection step, as illustrated in FIG. 1, the reservoir modification fluid 13 that reforms the wetting properties of the reservoir is pressed and injected through the injection well 11 and into the reservoir of the oil field 10 that contains the crude oil located between the injection well 11 and the production well 12.

In this step, the reservoir modification fluid 13 is able to alter the surfaces of the rock of the reservoir (oil reservoir) of the oil field 10 from an oil-wetting to a water-wetting.

It is thought that during this reservoir modification fluid injection step, the reservoir modification fluid 13 permeates particularly preferentially into the high-permeability oil reservoirs 17, thereby altering the surfaces of the rock from an oil-wetting to a water-wetting.

In the reservoir modification fluid injection step, at the same time as the reservoir modification fluid 13 alters the surfaces of the rock from an oil-wetting to a water-wetting, it is thought that the crude oil that exists in the oil reservoir, and particularly at least a portion of the crude oil that exists on the rock surfaces and in the rock pores and the like, desorbs from the rock surfaces and pores and shifts to a mobile state.

### <Primary Crude Oil Recovery Step>

In this embodiment, in succession with the injection of the reservoir modification fluid 13, the overflush fluid 14 is pressed and injected through the injection well 11 and into the oil reservoir.

Here, the expression “in succession” means that following the pressing and injecting of a predetermined amount of the reservoir modification fluid 13, the pressing and injecting of the overflush fluid 14 is started during execution of the reservoir modification fluid injection step, without waiting for the oil reservoir to be filled with the reservoir modification fluid 13.

In this step, the crude oil that has moved to a mobile state in the reservoir modification fluid injection step moves from the side of the injection well 11 toward the side of the production well 12 under the action of the overflush fluid 14, enabling the crude oil to be recovered from the oil reservoir through the production well 12.

In the primary crude oil recovery step, the overflush fluid 14 permeates particularly preferentially into the high-permeability oil reservoirs 17, enabling recovery of the crude oil from the oil reservoir.

In this embodiment, a method is described in which the overflush fluid 14 is pressed and injected into the oil reservoir in succession with the pressing and injecting of the reservoir modification fluid 13, but a method may also be employed in which the space in the oil reservoir from the side of the injection well 11 to the side of the production well 12 is filled with the reservoir modification fluid 13, before pressing and injecting the overflush fluid 14.

### <Secondary Crude Oil Recovery Step>

In this embodiment, in succession with the pressing and injecting of the overflush fluid 14, the foam-stabilizing fluid 15, and then the foam-forming fluid 16, are pressed and injected through the injection well 11 and into the oil reservoir.

Here, the expression “in succession” means that following the pressing and injecting of a predetermined amount of the overflush fluid 14, the pressing and injecting of the foam-stabilizing fluid 15 and the foam-forming fluid 16 is started during execution of the primary crude oil recovery step, without waiting for the recovery of crude oil generated by the overflush fluid 14.

In this step, the foam-stabilizing fluid 15 and the foam-forming fluid 16 may also be pressed and injected simultaneously, or the foam-stabilizing fluid 15 may be added in advance to the foam-forming fluid 16, with the resulting mixture then being pressed and injected.

By pressing and injecting the foam-stabilizing fluid 15 and the foam-forming fluid 16 into the oil reservoir, as illustrated in FIG. 2, foam 25 is formed in the spaces between the surfaces of the rock 21. As a result, the speed with which the foam-forming fluid 16 moves from the side of the injection well 11 toward the side of the production well 12 is suppressed, and the gas phase arising from the foam-forming fluid 16 can replace crude oil and the like that remains within rock pores and the like, thereby enabling improved recovery of the crude oil.

Here, the foam 25 includes surfactant stabilized foam or foam that has been stabilized by substances corresponding with surfactants such as nanoparticles.

In conventional foam EOR, as illustrated in FIG. 3, because the surfaces of the rock 21 inside the oil reservoir 20 are coated with crude oil 22, formation of the thin membrane 23 of water in the spaces between the rocks 21 in the oil reservoir 20 using nanoparticles or a surfactant may be suppressed, and formation of the thin membrane 23 of water may also be suppressed by the defoaming action of the crude oil 22. Accordingly, formation of the thin membrane 23 connecting between the surfaces of rock 21 inside the oil reservoir 20 has proven difficult, and formation of the foam 25 is also problematic, and a tendency has been observed for the gas phase to rapidly pass from the oil reservoir and be expelled out through the production well.

In this embodiment, the surfaces of the rock 21 are altered from an oil-wetting to a water-wetting in the reservoir modification fluid injection step. Accordingly, in the secondary crude oil recovery step, the foam 25 can be stabilized as illustrated in FIG. 2, and the crude oil can be recovered efficiently.

Further, in this embodiment, a tendency is observed for the foam 25 to form preferentially in the high-permeability oil reservoirs 17. In the low-permeability oil reservoirs 18 that has relatively low permeability compared with the high-permeability oil reservoirs 17, reformation of the rock surfaces proceeds poorly, and recovery of the crude oil by the overflush fluid can sometimes be difficult. However, in this embodiment, the foam 25 is formed preferentially in the high-permeability oil reservoirs 17, and as a result of this foam 25 formed in the high-permeability oil reservoirs 17, the problem that arises in which the gas phase generated by the foam-forming fluid 16 supplied to the low-permeability oil reservoirs 18 moves rapidly through the high-permeability oil reservoirs 17 toward the side of the production well 12 can be suppressed.

Accordingly, by employing the method of this embodiment, the oil phase in the low-permeability oil reservoirs 18 can be substituted efficiently with the gas phase, enabling an improvement in the recovery of crude oil.

### Embodiment 2

In this embodiment, the secondary crude oil recovery step is started following execution of the primary crude oil recovery step. In other words, with the exception of first moving the overflush fluid 14 from the side of the injection well 11 toward the side of the production well 12 and recovering the crude oil from the production well 12 in the primary crude oil recovery step, and then executing the secondary crude oil recovery step, the crude oil is preferably recovered using the same method as that described for Embodiment 1.

In those cases where first, in the primary crude oil recovery step, the overflush fluid 14 is moved from the side of the injection well 11 toward the side of the production well 12 and the crude oil is recovered from the production well 12, and the secondary crude oil recovery step is then executed thereafter, the secondary crude oil recovery step can be executed in a state where the low-permeability oil reservoirs 18 has also undergone satisfactory reservoir reformation.

### INDUSTRIAL APPLICABILITY

By employing the crude oil recovery method of the present invention, crude oil can be recovered effectively from reservoirs having oil reservoirs in which the rock surfaces are wet with oil.

### DESCRIPTION OF THE REFERENCE SIGNS

10: Oil field
11: Injection well
12: Production well
13: Reservoir modification fluid
14: Overflush fluid
15: Foam-stabilizing Quid
16: Foam-forming fluid
17: High-permeability oil reservoirs
18: Low-permeability oil reservoirs
19: Sealing layer
20: Oil reservoir
21: Rock
22: Crude oil
23: Thin membrane of water
24: Gas bubbles (gas phase)
25: Foam

1. A method for recovering crude oil, the method comprising:
a reservoir modification fluid injection step of pressing and injecting, through an injection well into a crude oil-containing reservoir between the injection well and a production well, a reservoir modification fluid that reforms the wettability of the reservoir,
a primary crude oil recovery step of pressing and injecting an overflush fluid through the injection well into the reservoir, thereby moving the crude oil contained in the reservoir from a side of the injection well toward a side of the production well, and enabling recovery of the crude oil from the reservoir via the production well, and
a secondary crude oil recovery step of pressing and injecting a foam-stabilizing fluid and a foam-forming fluid through the injection well into the reservoir, thereby moving the crude oil contained in the reservoir from the side of the injection well toward the side of the production well, and enabling recovery of the crude oil from the reservoir via the production well.

2. The method for recovering crude oil according to claim 1, wherein the secondary crude oil recovery step is started during execution of the primary crude oil recovery step.

3. The method for recovering crude oil according to claim 1, wherein the secondary crude oil recovery step is started following execution of the primary crude oil recovery step.

4. The method for recovering crude oil according to claim 1, wherein the reservoir modification fluid is at least one type of fluid selected from a group consisting of first nanoparticle-containing fluids, water vapor, surfactant-containing fluids, polymer compound-containing fluids, and low-salinity water.

5. The method for recovering crude oil according to claim 4, wherein the first nanoparticle-containing fluid comprises nanoparticles and a dispersion medium, and the nanoparticles have hydrophilicity.

6. The method for recovering crude oil according to claim 5, wherein the nanoparticles are formed from one component, or two or more components, selected from a group consisting of silicon, aluminum, titanium, iron, zinc, copper, nickel, zirconium, tin and magnesium.

7. The method for recovering crude oil according to claim 5, wherein a maximum particle size of the nanoparticles is at least 1 nm but not more than 100 nm.

8. The method for recovering crude oil according to claim 5, wherein the dispersion medium comprises at least one fluid selected from a group consisting of water, natural gas, carbon dioxide, air, nitrogen, methane and hydrogen.

9. The method for recovering crude oil according to claim 4, wherein the surfactant contained in the surfactant-containing fluid is one or more surfactants selected from a group consisting of cationic surfactants, anionic surfactants, amphoteric surfactants and nonionic surfactants.

10. The method for recovering crude oil according to claim 1, wherein the overflush fluid comprises at least one fluid selected from a group consisting of water, natural gas, carbon dioxide, air, nitrogen, methane and hydrogen.

11. The method for recovering crude oil according to claim 1, wherein the foam-stabilizing fluid is at least one fluid selected from a group consisting of surfactant-containing fluids and second nanoparticles-containing fluids.

12. The method for recovering crude oil according to claim 1, wherein the foam-forming fluid is at least one fluid selected from a group consisting of natural gas, carbon dioxide, air, nitrogen, methane and hydrogen.
